(19) United States
(12) Patent Application Publication
(10) Pub. No.: US 2023/0326630 A1
(43) Pub. Date: Oct. 12, 2023

(54) COAXIAL CABLE AND SIGNAL TRANSMISSION ASSEMBLY THEREOF

(71) Applicant: Edom Technology Co., Ltd, Taipei (TW)

(72) Inventor: HSIANG-JEN WANG, Taipei (TW)

(21) Appl. No.: 17/846,701

(22) Filed: Jun. 22, 2022

Related U.S. Application Data
(60) Provisional application No. 63/329,548, filed on Apr. 11, 2022.

(51) Int. Cl. H01B 11/20

(52) U.S. Cl. CPC H01B 11/20; H01B 11/1891

(57) ABSTRACT

This invention is a coaxial cable and a signal transmission assembly thereof. The coaxial cable includes a conductive cored wire, an insulating tape and a metal foil Mylar film a conductive layer and an outer jacket. The conductive cored wire includes an outer peripheral surface. The insulating tape is wrapped onto the outer peripheral surface of the conductive cored wire in a spiral winding manner or a longitudinal wrapping manner. The metal foil Mylar film is wrapped onto the insulating tape in a spiral winding manner, a longitudinal wrapping manner, and the conductive layer is wrapped onto the metal foil Mylar film. The jacket is wrapped onto the conductive layer. A distance between the conductive core wire and the metal foil Mylar film can be adjust by control the number of wrapping turns of the insulating tape to improve the yield rate of the coaxial cable manufacturing.

This non-provisional application claims priority claim under 35 U.S.C. § 119(e) on American Patent Application 63/329,548 filed Apr. 11, 2022, the entire contents of which are incorporated herein by reference.

### FIELD OF THE INVENTION

This disclosure is related to a coaxial cable and signal transmission assembly thereof, particularly to a coaxial cable and signal transmission assembly thereof with an insulating tape formed between a conductive cored wire and a shield layer.

### BACKGROUND

The signal transmission requires an increasing frequency of signal transmission and low transmission attenuation, thereby increasing the transmission distance of high-frequency signals. A major factor affecting the transmission distance is the dielectric constant of the insulator between the conductive cored wire and the shield layer. In the usage of polytetrafluoroethylene (PTFE) as the insulator in the art of a high-frequency transmission coaxial cable, a PTFE insulator is mostly formed by foaming and/or extrusion.

The micro-bubble distribution and/or the micro-bubble size in the PTFE insulator formed by foaming and/or extrusion are difficult to control. Thereby variable and uncontrollable dielectric constant values in the entire coaxial cable are caused. In addition, in the production line, it is also difficult to control on-site precise thickness adjustment for the PTFE insulator formed by foaming and/or extrusion, much less control on-site precise thickness adjustment for the micro-bubble distribution and/or micro-bubble size.

The above issues will affect the impedance due to the uncontrollable value of the dielectric constant and distribution thereof, thereby reducing the transmission distance and quality of high-frequency signals.

However, as the increasing signal transmission frequency of the coaxial cable, the transmission distance and quality of high-frequency signals are greatly limited due to the traditional manufacturing methods with controlling forming and/or extrusion parameters and conditions for forming polytetrafluoroethylene insulators. New structures and manufacturing methods are required to solve these issues.

### SUMMARY

In order to solve an issue existing in the art, this disclosure provides a coaxial cable, including a conductive cored wire, an insulating tape and a shield layer. The conductive cored wire includes an outer peripheral surface. The insulating tape is wrapped onto the outer peripheral surface of the conductive cored wire. The shield layer is wrapped onto the insulating tape.

In at least one embodiment of this disclosure, a material of the insulating tape is polytetrafluoroethylene (PTFE).

In at least one embodiment of this disclosure, the insulating tape is wrapped onto the outer peripheral surface through spiral winding and wrapping, longitudinal winding or in a combination of the spiral winding manner and the longitudinal wrapping manner.

In at least one embodiment of this disclosure, the coaxial cable further includes a conductive layer and a jacket, the conductive layer is formed on the shield layer, the jacket is formed on the conductive layer.

This disclosure further provides a signal transmission assembly including a plurality of coaxial cables as above-mentioned and an outer jacket. The coaxial cables are disposed within the outer jacket.

In at least one embodiment of this disclosure, the signal transmission assembly further includes a conductor disposed within the outer jacket.

In at least one embodiment of this disclosure, the signal transmission assembly further includes a conductor disposed outside the outer jacket.

In at least one embodiment of this disclosure, the coaxial cables and the outer jacket constitutes a sub cable set, the signal transmission assembly further includes a connecting portion and an another sub cable set; wherein a structure of the another sub cable set is the identical to a structure of the sub cable set, and the connecting portion connects the sub cable set and the another sub cable set, so as to constitute to a cable set.

In at least one embodiment of this disclosure, the signal transmission assembly further includes a conductor disposed between the sub cable set and the another sub cable set.

This disclosure further provides a signal transmission assembly including at least one coaxial cable as above-mentioned, a conductive wire, an outer conductive layer and an outer jacket. The coaxial cable and the conductive wire are disposed within the outer conductive layer. The outer conductive layer is disposed between the outer jacket and the coaxial cable, and between the outer jacket and the conductive wire.

The key characteristic affecting the transmission distance and quality of high-frequency signals under high-frequency applications is impedance of the transmission medium. That is, the dielectric constant of a coaxial cable is important, and the distribution of the impedance value of the dielectric layer is significantly affected by sizes and distribution of micro-bubbles in the dielectric layer. In this disclosure, an insulating tape is utilized to be wrapped onto the conductive cored wire to serve as a dielectric layer. Sizes and distribution of micro-bubbles in insulating tape is much easier to be controlled. Therefore, distance and quality of high-frequency signals under high-frequency applications can be significantly improved in this disclosure. Furthermore the production yield of the coaxial cable can be also improved.

In addition, thickness of the dielectric layer is easily controlled. For example, by changing spiral winding turns per unit length of the insulating layer, thickness of the dielectric layer is changed. The production conditions of the coaxial cable can be adjusted quickly on-site, and the production yield of the coaxial cable can be improved.

### BRIEF DESCRIPTION OF THE DRAWINGS

FIG. 1 is a schematic diagram of a coaxial cable according to an embodiment of this disclosure.

FIG. 2 is a schematic diagram of a coaxial cable according to another embodiment of this disclosure.

FIG. 3 is a schematic diagram of an embodiment of this disclosure, showing a single conductive cored wire and an insulating are wrapped by a conductive layer formed by spiral winding metal wire.

FIG. 4 is a schematic diagram of an embodiment of this disclosure, showing a single conductive cored wire and an insulating are wrapped by a conductive layer formed by a braided metal net.

FIG. 5 is a schematic diagram of a signal transmission assembly according to an embodiment of this disclosure.

FIG. 6 is a schematic diagram of a signal transmission assembly according to another embodiment of this disclosure.

FIG. 7 is a schematic diagram of a signal transmission assembly according to another embodiment of this disclosure.

FIG. 8 is a schematic diagram of a signal transmission assembly according to another embodiment of this disclosure.

FIG. 9 is a schematic diagram of a signal transmission assembly forming a cable set according to an embodiment of in this disclosure.

FIG. 10 is a schematic diagram of a high frequency signal transmission assembly according to an embodiment of this disclosure.

### DETAILED DESCRIPTION OF THE PREFERRED EMBODIMENTS

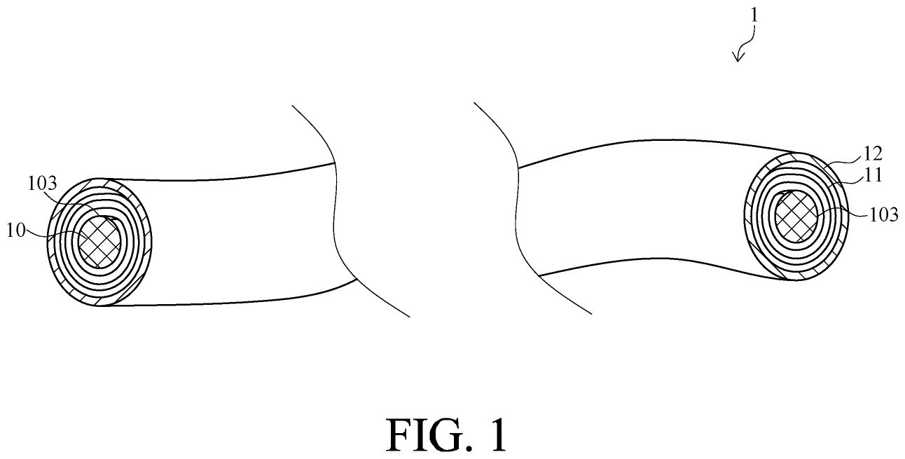

FIG. 1 is a schematic diagram of a coaxial cable a according to an embodiment of this disclosure. As shown in FIG. 1, the coaxial cable 1 includes a conductive cored wire 10, an insulating tape 11 and a shield layer 12. Specifically, the conductive cored wire 10 includes an outer peripheral surface 103. The insulating tape 11 is wrapped onto an outer peripheral surface 103 of the conductive cored wire 10, and the shield layer 12 is wrapped onto the insulating tape 11.

In one embodiment, a material of the insulating tape 11 is polytetrafluoroethylene (PTFE). Generally, the insulating tape 11 is fully wrapped onto the outer peripheral surface 103 of the conductive cored wire 10. When it is needed to connect the coaxial cable 1, both the insulating tape 11 and the shield layer 12 corresponding to the parts of the two end of the conductive cored wire 10 are removed in accordance with requirement. The insulating tape 11 is wrapped onto the outer peripheral surface in a spiral winding manner, a longitudinal wrapping manner, or in a combination of the spiral winding manner and the longitudinal wrapping manner. Noteworthy in that the insulating tape 11 wrapped between the outer peripheral surface 103 and shield layer 12 means: no objects formed through other method and/or material between the outer peripheral surface 103 and the shield layer 12, only the insulating tape 11 is directly wrapped onto the outer peripheral surface 103. Alternatively, the conductive cored wire 10 is a metallic conductive wire. Furthermore, the conductive cored wire 10 is a copper conductive wire or an electroplated metallic conductive wire.

The shield layer 12 may be a single-layer structure or a multi-layer structure, and the shield layer 12 may include the structure of a metallic conductor etc., so as to form a Faraday cage, such that the conductive cored wire 10 transmits signals without interference, and the surrounding interference is also avoided while the signals are transmitted through the conductive cored wire 10.

As shown in FIG. 1, the shield layer 12 of FIG. 1 is a single layer structure with a metallized PET film 122 (such as a metal foil Mylar® film), and the metallized PET film 122 is wrapped onto the insulating tape 11. In detail the metallized PET film 122 may be an aluminum foil PET film, and pre-processed into strips. As well as alternatively the metallized PET film 122 is wrapped onto the insulating tape 11 in a spiral winding manner, a longitudinal wrapping manner, or in a combination of the spiral winding manner and the longitudinal wrapping manner.

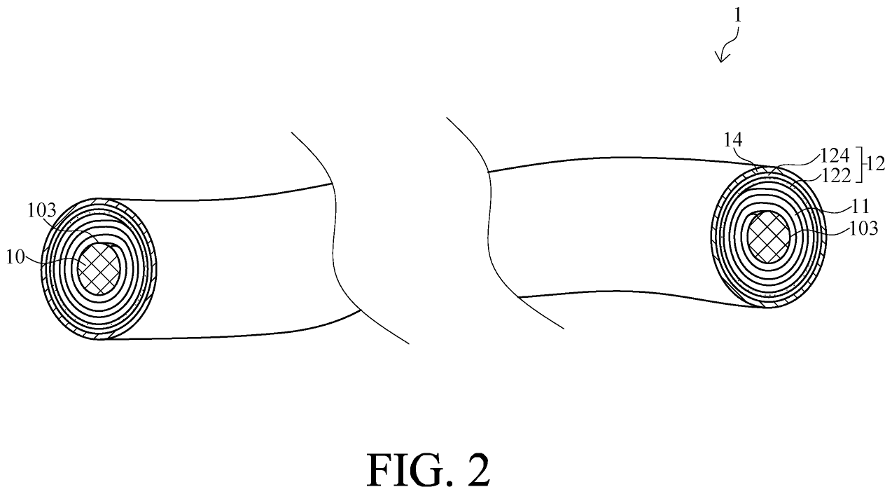

Another embodiment of this disclosure is shown in FIG. 2, the shield layer 12 of FIG. 2 is a structure including two sub-layers, the two sub-layer include the metallized PET film 122 (metal foil PET film) and the conductive layer 124. The metallized PET film 122 is wrapped onto the insulating tape 11, and the conductive layer 124 is wrapped onto the metallized PET film 122.

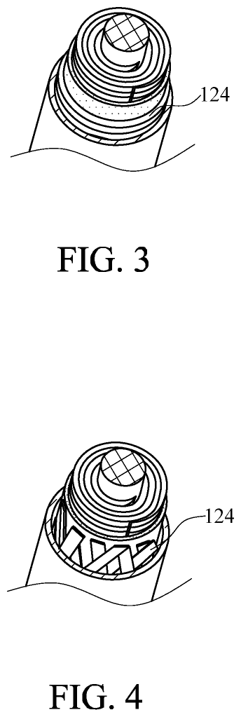

The conductive layer 124 is constituted of a metal wire made of a high conductive material, for example a copper wire. In particular, the metal wire such as the copper wire is wrapped over the metallized PET film 122 in a spiral winding manner, so as to form the conductive layer 124, as shown in FIG. 3. Or the copper wire is braided to be a metal braid for the usage of the conductive layer 124, and then the conductive layer 124 is sleeved outside the metallized PET film 122, as shown in FIG. 4. Similarly, the conductive layer 124 is a composite structure including both a metal wire winded in a spiral winding manner and a braided metal net.

Additionally, as shown in FIG. 2, the coaxial cable 10 further includes a jacket 14 wrapped onto the shield layer 12. The jacket provides insulation, waterproof and other protections, and improves mechanism strength of the coaxial cable 10. Alternatively, a material of the jacket 14 is polyvinyl chloride (PVC), low density polyethylene (LDPE), fluorinated ethylene propylene (FEP) or thermoplastic elastomer (TPE).

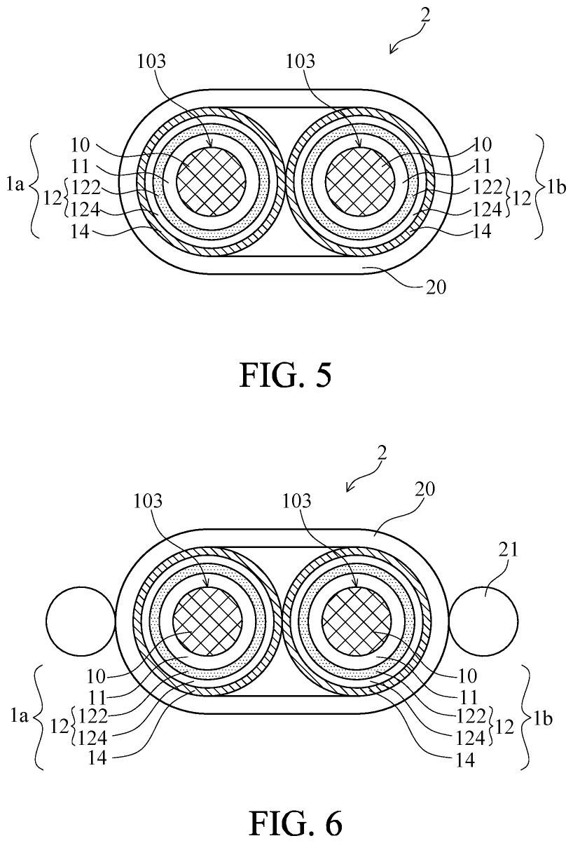

FIG. 5 to FIG. 8 are schematic diagrams of embodiments of signal transmission assembly in this disclosure.

As shown in FIG. 5, a second embodiment of this disclosure includes a plurality of coaxial cables 1a, 1b as described in the first embodiment. A quantity of the coaxial cable of this embodiment is two, so as to form a signal transmission assembly 2. Specifically, the signal transmission assembly 2 includes the coaxial cables 1a, 1b and an outer jacket 20. The coaxial cables 1a, 1b are disposed within the outer jacket 20. Thereby a two-axial signal transmission assembly is formed by the two single coaxial cables (i.e. having single conductive cored wire) 1a, 1b.

In an embodiment as shown in FIG. 6, the signal transmission assembly further includes a conductor 21 disposed outside the outer jacket 20. Alternatively, the quantity of the conductor 21 is two. Furthermore, the conductor 21 is a drain wire. Further alternatively, two conductors 21 and the conductive cored wires of the two single coaxial cables 1a, 1b are parallel to each other.

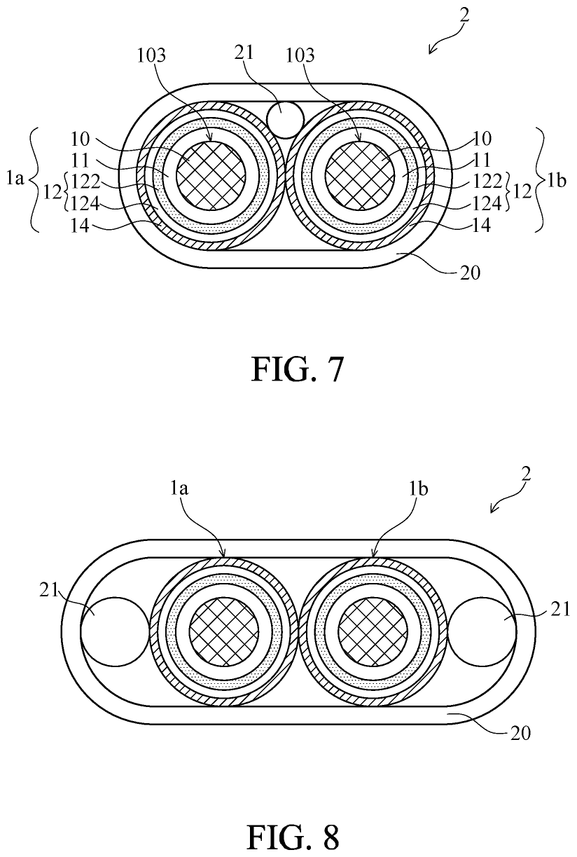

In an embodiment as shown in FIG. 7 and FIG. 8, the signal transmission assembly 2 further includes a conductor 21 disposed within the outer jacket 20. Alternatively, the quantity of the conductor 21 is one (as shown in FIG. 7) or two (as shown in FIG. 8). Furthermore, when the quantity of the conductor 21 is one, the conductor 21 is disposed between the jackets 14 of the coaxial cables 1a, 1b, as shown in FIG. 7. If the quantity of the conductor 21 is two, one of the conductors 21 is disposed between the jacket 14 of the coaxial cable 1a and the outer jacket 20; another conductor 21 is disposed between the jacket 14 and the outer jacket 20 of the coaxial cable 1b. Furthermore, two conductors 21 and the conductive cored wires of the two single coaxial cables 1a, 1b are parallel to each other, as shown in FIG. 8.

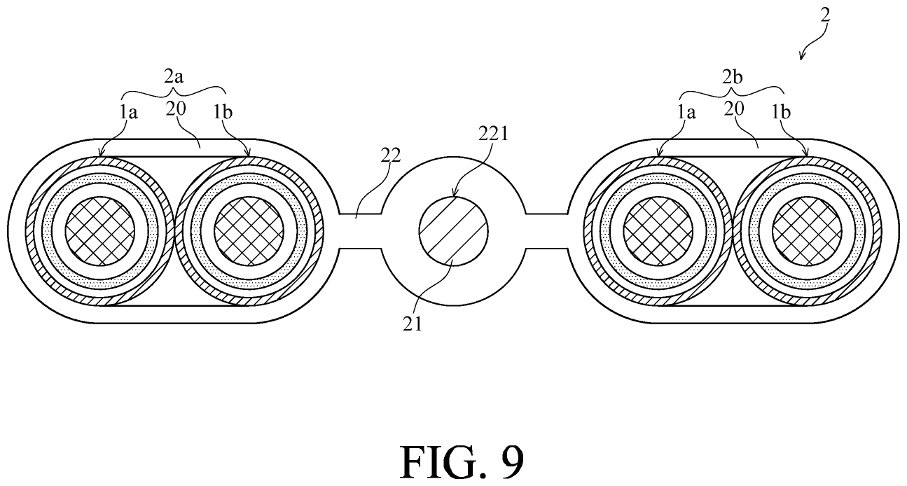

In another embodiment as shown in FIG. 9, the signal transmission assembly 2 includes a sub cable set 2a. The sub cable set 2a includes two coaxial cables 1a, 1b and the outer jacket 20. The signal transmission assembly 2 further includes another sub cable set 2b and a connecting portion 22. The another sub cable set 2b is substantially identical to the sub cable set 2a. The connecting portion 22 is connected to the sub cable set 2a and the another sub cable set 2b, so as to constitute a cable set.

In one embodiment, the signal transmission assembly 2 further includes a conductor 21 disposed between the sub cable set 2a and the another sub cable set 2b. In an example, an accommodating space 221 is formed in the connecting portion 22 between the sub cable set 2a and another sub cable set 2b, so as to accommodate the conductor 21. In an embodiment, the conductor 21 is any one of a power line, a ground line, and a drain wire. Furthermore, the conductor 21 and the conductive cored wires of the single cables in the sub cable set 2a and another sub cable set 2b are arranged parallel. In an example, the connecting portion 22 and the jackets 14 of the sub cable set 2a and another sub cable set 2b are formed by extrusion molding.

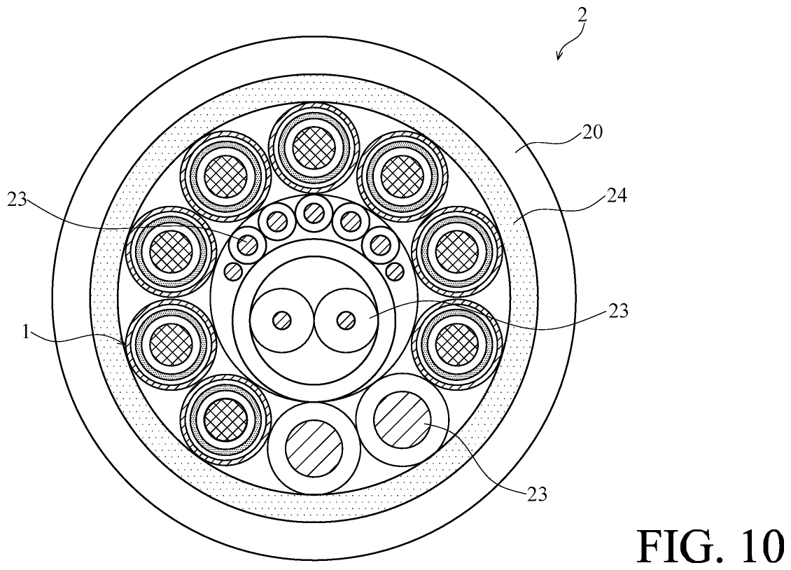

FIG. 10 is a schematic diagram of another embodiment of a signal transmission assembly 2 in this disclosure. As shown in FIG. 10, besides the single coaxial cable 1 shown in FIG. 2, the signal transmission assembly 2 of this disclosure further includes a conductive wire 23, an outer conductive layer 24 and an outer jacket 20. Furthermore, a high frequency signal transmission assembly is formed alternatively, wherein the coaxial cable 1 and the conductive wire 23 are disposed within the outer conductive layer 24, the outer conductive layer 24 is disposed between the outer jacket 20 and both the coaxial cable 1 and the conductive wire 23.

In an embodiment, the outer conductive layer 24 is similar to the conductive layer 124 and formed by spiral winding a metal wire (such as the copper wire); or the outer conductive layer 24 is a composite structure including a spiral winded metal wire and a braided metal net.

Alternatively, the conductive wire 23 is any one of a CC line, a SBU1 line, a SBU2 line, a Vcon line, a power line and a drain wire. Reasonably, a plurality of conductive wires 23 are of a single type as mentioned above or a combination of at least part of types as mentioned above.

The outer conductive layer 24 disposed between the outer jacket 20 and both the conductive wire 23 and the jacket 14 means that the conductive wire 23 and the jacket 14 are formed within the outer conductive layer 24, and the outer jacket 20 is wrapped outside the outer conductive layer 24.

In an embodiment, the high frequency signal transmission assembly is a USB coaxial cable, a HDMI coaxial cable, a display port (DP) coaxial cable or a small form-factor pluggable transceiver (SFP) coaxial cable.

The arrangement in FIG. 10 is an example. The quantity, the type and/or arrangement of the single coaxial cable, and the conductive wire 23 are determined according to signal transmission requirement and/or a wire diameter of American Wire Gauge (AWG).

For example, there are two drain wires (D+ and D−) at a middle part of the high frequency signal transmission assembly 2, the drain wires are surrounded with a jacket radially from the outside by the middle part of the high frequency signal transmission assembly 2. At least part of jacket is arranged around with CC line, SBU1 line, SBU2 line, two Vcon lines. The conductive wire 23 as mentioned above is surrounded with, for example, the plurality of single coaxial cables 1 and two power lines. Then, the outer conductive layer 24 and the outer jacket 20 are radially wrapped outside the plurality of single coaxial cable 1 and the two power lines in sequence.

The above disclosure is only the preferred embodiment of this disclosure, and not used for limiting the scope of this disclosure. All equivalent variations and modifications on the basis of shapes, structures, features and spirits described in the claims of this disclosure should be included in the claims of this disclosure.

1. A coaxial cable, comprising:
a conductive cored wire, including an outer peripheral surface;
an insulating tape, wrapped onto the outer peripheral surface of the conductive cored wire in a spiral winding manner or a longitudinal wrapping manner;
a metal foil Mylar film, wrapped onto the insulating tape in a spiral winding manner or a longitudinal wrapping manner, wherein apart from the insulating tape, no other objects are provided between the outer peripheral surface of the conductive cored wire and the metal foil Mylar film;
a conductive layer wrapped onto the metal foil Mylar film; and
a jacket wrapped onto the conductive layer.

2. (canceled)

3. The coaxial cable according to claim 1, wherein a material of the insulating tape is polytetrafluoroethylene.

4. (canceled)

5. A signal transmission assembly comprising:
a plurality of coaxial cables, wherein each of the coaxial cables comprising:
a conductive cored wire, including an outer peripheral surface;
an insulating tape, wrapped onto the outer peripheral surface of the conductive cored wire in a spiral winding manner or a longitudinal wrapping manner;
a metal foil Mylar film, wrapped onto the insulating tape in a spiral winding manner or a longitudinal wrapping manner, wherein apart from the insulating tape, no other objects are provided between the outer peripheral surface of the conductive cored wire and the metal foil Mylar film;
a conductive layer wrapped onto the metal foil Mylar film; and
an outer jacket, wherein plurality of coaxial cables are disposed within the outer jacket.

6. The signal transmission assembly according to claim 5, further comprising a conductor disposed within the outer jacket.

7. The signal transmission assembly according to claim 5, further comprising a conductor disposed outside the outer jacket.

8. The signal transmission assembly according to claim 5, wherein the coaxial cables and the outer jacket constitute a sub cable set, the signal transmission assembly further comprising a connecting portion and an another sub cable set identical to the sub cable set constituted by the coaxial cables and the outer jacket; the connecting portion connects the sub cable set and the another sub cable set, so as to constitute a cable set.

9. The signal transmission assembly according to claim 8, further comprising a conductor disposed between the sub cable set and the another sub cable set.

10. A signal transmission assembly, comprising
at least one coaxial cable, comprising:
a conductive cored wire, including an outer peripheral surface;
an insulating tape, wrapped onto the outer peripheral surface of the conductive cored wire in a spiral winding manner or a longitudinal wrapping manner;
a metal foil Mylar film, wrapped onto the insulating tape in a spiral winding manner or a longitudinal wrapping manner, wherein apart from the insulating tape, no other objects are provided between the outer peripheral surface of the conductive cored wire and the metal foil Mylar film; and
a conductive layer wrapped onto the metal foil Mylar film;
a conductive wire;
an outer conductive layer, wherein the coaxial cable and the conductive wire are disposed within the outer conductive layer; and
an outer jacket, wherein the outer conductive layer is disposed between the outer jacket and the coaxial cable, and between the outer jacket and the conductive wire.
